(19) United States
(12) Patent Application Publication
(10) Pub. No.: US 2003/0066385 A1
(43) Pub. Date: Apr. 10, 2003

(54) Clipless bicycle pedal system

(76) Inventors: Paul J. Blanchette, Burlington, CT (US); Craig Blanchette, Burlington, CT (US)

Correspondence Address: ALIX YALE & RISTAS LLP, 750 MAIN STREET, SUITE 1400, HARTFORD, CT, 06103, US

(21) Appl. No.: 09/971,422

(22) Filed: Oct. 5, 2001

(51) Int. Cl. B62M 3/08

(52) U.S. Cl. 74/594.6

(57) ABSTRACT

A clipless pedal system incorporates a static hook plate fixable to the pedal of a cycling machine and an SPD compatible cleat with resiliently biased retaining mechanisms engageable with the hook plate to form a cycle/rider power transfer interface. Each hook plate includes front and rear arcuate hooks that together define a center of rotation for the cleat. The front and rear hooks define arcuate retaining channels that receive the retaining mechanisms to engage the cleat to the hook plate. The received cleat is permitted to rotate relative to the hook plate between inward and outward release points defined by release ramps at either end of each retaining channel. The hook plates may be configured with asymmetrical inward and outward release points. Alternatively, arcuate fastener openings may permit the hook plates to be mounted at a variety of angular orientations relative to the pedal. Pedal pads permit use of a bicycle equipped with the clipless pedal system without engagement of the rider's foot to the pedal.

### BACKGROUND OF THE INVENTION

1. Field of the Invention

The invention generally relates to a cleat and pedal combination known as a clipless pedal and more particularly to a clipless bicycle pedal system in which super-elastic wireform materials retained in the cleat provide both the biasing force and retaining interface between the cleat and the pedal.

1. Description of the Related Art

In a pedal powered machine the interface between the human foot and pedal is critical to efficient power transfer from the human body to the machine. In the past, cages and straps known as toe clips were arranged so that the front portion of the cyclist's shoe covered foot were retained to the pedal by downward force exerted over the top of the shoe by the strap. This arrangement often caused discomfort by placing pressure on the top of the foot and could be extremely hazardous to the cyclist by retaining the foot attached to the pedal during a crash.

Clipless bicycle pedal systems eliminate the toe clip and strap. The shoe is retained to the pedal by means of a cleat fitted to the cyclist's shoe. The cleat is engaged by a complementary mechanism attached to the crank arm of the bicycle. Various designs of clipless bicycle pedal and cleat combinations have been proposed and manufactured. For example, U.S. Pat. Nos. 5,046,382; 5,862,716; 5,131,291; 4,882,946; 5,131,291; and 4,942,778 disclose various configurations of clipless bicycle pedal systems for providing a cyclist's shoe/pedal interface.

Cyclist experience with available clipless pedal systems has revealed both the shortcomings of current clipless pedal systems as well as a collection of desirable attributes which would ideally be present in a clipless pedal/cleat combination. Some attributes are desirable in any bicycle pedal, e.g., strength, durability, lightweight, etc. Other attributes are not readily apparent and require a discussion of the cyclist shoe/cleat/pedal interface in the context of a clipless pedal system.

Generally speaking, clipless pedal systems are provided with a spring-biased mechanism for establishing a releasable energy-delivery connection between the cleat affixed to the sole of the cyclist's shoe and the pedal fixed to the end of the crank arm of a pedal powered machine. The bicycle/rider interface requires a high strength and reliable foot/pedal connection. Contradictorily, this reliable, high strength connection must also release predictably under certain conditions to prevent serious injury to the rider. Many clipless bicycle pedals include spring-loaded retaining mechanisms configured to release a static cleat upon exposure to predetermined force levels and/or angular thrusts in a manner similar to a ski binding. Other prior art arrangements comprise a static pedal with resilient retaining mechanisms incorporated in the cleat.

Many prior art clipless pedal systems retain the cyclist's foot in a particular orientation to the pedal or exert spring pressure on the cyclist's foot toward a particular orientation relative to the pedal. Since every human body has a different shape, each rider's foot will have a unique orientation to the pedal. This angular orientation varies throughout each pedal cycle. There are also an infinite variety of riding styles, each of which influence the angular orientation of the rider's feet relative to the pedals. Riding conditions, obstacles and body position may also require the rider to alter the position of his feet relative to the pedals. Systems that force the rider's foot into a particular orientation place unnecessary stress on the rider's feet and legs. In particular, ankle, knee and hip discomfort commonly result from a fixed or spring biased foot/pedal interface. Muscle, connective tissue and joint damage can result.

Ideally, the rider's foot is free to establish it's own position relative to the pedal. This position should be able to change continuously during the pedal cycle with little or no resistance. This concept is called “float”. Float permits the rider to alter the position of his foot relative to the pedal while still retaining a power delivery interface with the pedal. Restated, the rider can move his heel inward or outward relative to the bicycle without disengaging his foot from the pedal.

A common difficulty associated with clipless pedal systems is establishing the shoe/pedal connection. Many clipless pedal systems provide a narrow entry angle that makes engaging the cleat and pedal awkward. Also, many clipless pedal systems fail to provide a positive indication that the cleat/pedal connection has been made. These related deficiencies of prior art clipless pedal systems make them difficult to use and keep many novice riders from attempting to use them.

A clipless pedal system must also provide for release of the rider's foot from the pedal. This must occur predictably and only under certain conditions. Premature release can cause serious injury to the rider and other riders nearby. Most clipless pedal systems are configured to release when the angular orientation of the rider's foot relative to the pedal exceeds a predetermined limit. This angular orientation can occur toward the bicycle (inwards) or away from the bicycle (outwards). Ideally, the rider's foot is permitted to move or float between the inward and outward release points while remaining connected to the pedal. Once an inward or outward release point is exceeded, the clipless pedal system should release the cleat.

Many prior art clipless pedal systems fail to provide sufficient range of motion or float between release points. The result of this deficiency is frequent unintended release. Excessive float can result in failure to release when required. Float requirements are different for different riders and will change for the same rider depending on riding conditions and experience. Generally speaking, road riders need less float than off-road riders. Also, more experienced riders of all types can benefit from more float. Because of the bicycle/rider configuration, inward release points ideally occur at smaller angular orientations than outward release points. Some prior art clipless pedal systems provide for adjustable float and may provide smaller inward release angles than outward release angles.

Another frequently mentioned deficiency of prior art clipless pedal systems is poor performance when exposed to mud in off-road conditions. The often complex, spring biased cleat retention mechanisms tend to accumulate mud and malfunction.

One trend in clipless pedal design is toward a small pedal. This trend deprives the rider of an adequate foot support surface. The result is that excessive pressure is exerted on a small area of the ball of the rider's foot, causing pain and fatigue on long rides. A possible solution is to increase the stiffness of the sole of the cycling shoe. However, this makes walking in the cycling shoes more difficult, counter to the wishes of many cyclists. In addition, a very small foot support surface makes it very uncomfortable and potentially dangerous to ride a bicycle equipped with small-body clipless pedals in shoes not specifically designed to accept the pedals.

One of the most popular clipless pedal systems is the SPD system produced by Shimano®. Riders particularly appreciate the SPD shoe design in which a compact cleat is recessed into the sole of the shoe. The recessed cleat does not interfere with walking in the cycling shoes. As a result of the popularity of the SPD format, most manufacturers of cycling shoes produce shoe compatible with this format. Because many SPD compatible shoes are available, manufacturers of clipless pedal systems are now producing competing clipless pedal systems in which the cleat is compatible or adaptable to an SPD cycling shoe.

There is a need in the art for a clipless pedal system with the following features:

1. Easy entry with a positive, easily detected engagement between the cleat and pedal;

2. A cleat and pedal combination that guide the cyclist's foot making pedal cleat engagement easy;

3. No force exerted on cyclist's shoe toward a particular orientation relative to the pedal otherwise known as “free float”;

4. Adjustable angles of release;

5. Adjustable release force levels;

6 Pedals permitting entry from both top and bottom surfaces;

7. SPD compatibility;

8. Simple configuration for reliable operation even in wet and/or muddy environments; and

9. An optimal foot support surface.

### SUMMARY OF THE INVENTION

A clipless pedal system in accordance with the present invention comprises a static hook plate and mating cleat where the cleat includes at least one resiliently biased retaining mechanism to engage the hook plate. The hook plate preferably includes front and rear hooks that define front and rear arcuate retaining channels for receiving the retaining mechanisms. A preferably circular cleat is permitted to rotate freely relative to the hook plate around an axis of rotation passing generally through the center of the hook plate and cleat. Free rotation of the cleat relative to the hook plate is permitted between inward and outward release points defined by inward and outward release ramps at the lateral extremities of the front and rear retaining channels.

The front and rear hooks may be arranged to define different inward and outward release points relative to the cycling machine. Alternatively, the hook plates may be provided with fastener mounting holes configured as arcuate slots that permit the rider to mount the hook plates in a variety of angular orientations relative to the pedal. The inward and outward release ramps may be differently configured, preferably with the outward release ramp permitting release with less resistance than the inward release ramp.

The cleat is preferably SPD compatible and includes at least one resiliently biased retaining mechanism. The retaining mechanism may comprise a wireform protruding from one or more openings at the periphery of the cleat body. Multiple wireforms may also be used. The retaining mechanisms may alternatively comprise one or more rigid members where one or both of the rigid members are biased to protrude through openings in the periphery of the cleat body. The wireforms or biasing members are preferably constructed from nickel titanium shape memory alloy material. The elastic properties of shape memory alloy material can be adjusted by heat treatment and cold working rather than by altering the diameter of the wireform material. Thus, the manufacturing tolerances of the cleat body and hook plates can remain the same while the force exerted by the wireforms is altered.

The cleat body may be configured as a monolithic unit or may be laterally split to facilitate insertion or removal of the various retaining mechanisms. Relief ports for mud and debris communicate with the retaining channels in the cleat body. Accumulated mud or debris are forced out these relief ports so that the function of the retaining mechanisms are not impeded.

It is an object of the present invention to provide a new and improved clipless bicycle pedal system that overcomes the above-described deficiencies of the prior art while attaining many of the ideal characteristics described above.

Another object of the invention is to provide a new and improved clipless bicycle pedal system having a simplified configuration whose functionality is unimpaired by the presence of contaminants such as water, oil or mud.

A further object of the present invention is to provide a new and improved clipless bicycle pedal system of compact, lightweight and efficient design.

These and other objects, features and advantages of the invention will become readily apparent to those skilled in the art upon reading the description of the preferred embodiments in conjunction with the accompanying drawings.

### BRIEF DESCRIPTION OF THE DRAWINGS

FIG. 1 is a top view partly in phantom of a clipless pedal interface in accordance with the present invention;

FIG. 2 is a side sectional view of the clipless pedal interface of FIG. 1 taken along line 2-2 thereof;

FIG. 3 is a top view partly in phantom and partly in section of the SPD compatible cleat illustrated in the clipless pedal interface of FIG. 1;

FIG. 4 is a side sectional view through the SPD compatible cleat of FIG. 3 taken along line 4-4 thereof;

FIG. 5 is a top view partly in phantom of the cleat body of the SPD compatible cleat illustrated in FIG. 3;

FIG. 6 is a side sectional view partly in phantom of the cleat body of FIG. 5;

FIG. 6A is a side sectional view partly in phantom of an alternative two peice embodiment of the cleat body of FIG. 5;

FIG. 7 is a top view partly in phantom of a symmetrical release hook plate suitable for use in conjunction with the SPD compatible cleat illustrated in FIG. 3;

FIG. 8 is a side sectional view through the symmetrical release hook plate of FIG. 7 taken along line 8-8 thereof;

FIG. 9 is a top plan view partly in phantom of the asymmetrical release hook plate illustrated in conjunction with the SPD compatible cleat in FIG. 1;

FIG. 9A is an enlarged view of a portion of the asymmetrical release hook plate of FIG. 9;

FIG. 10 is a side sectional view through the asymmetrical release hook plate of FIG. 9 taken along line 10-10 thereof;

FIG. 11 is a bottom plan view, partly in phantom, of a pedal pad for use in conjunction with the asymmetrical release hook plate of FIG. 9;

FIG. 12 is a sectional view through the pedal pad of FIG. 11, taken along line 12-12 thereof;

FIG. 13 is a top view, partly in phantom of an alternative cleat body in accordance with the present invention;

FIG. 14 is a side sectional view through the cleat body of FIG. 13 taken along line 14-14 thereof;

FIG. 15 is a top view, partly in phantom of an alternative cleat body in accordance with the present invention;

FIG. 16 is a side sectional view through the cleat body of FIG. 15 taken along line 16-16 thereof;

FIG. 17 is a top view, partly in phantom of an alternative cleat body in accordance with the present invention;

FIG. 18 is a side sectional view through the cleat body of FIG. 17 taken along line 16-16 thereof;

FIG. 19 is a top view, partly in phantom of an alternative cleat body in accordance with the present invention; and

FIG. 20 is a side sectional view of the cleat body of FIG. 19 taken along lile 19-19 thereof.

### DETAILED DESCRIPTION OF THE PREFERRED EMBODIMENT

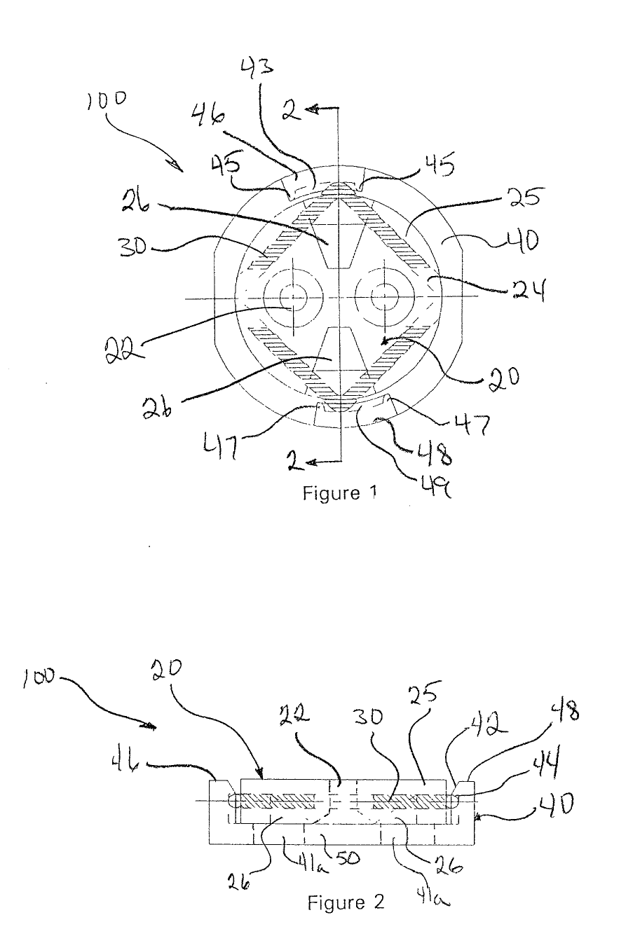

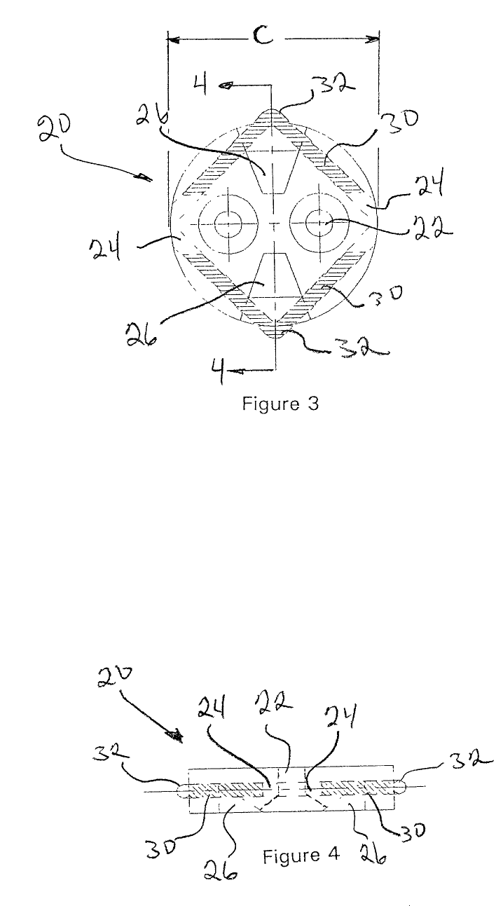

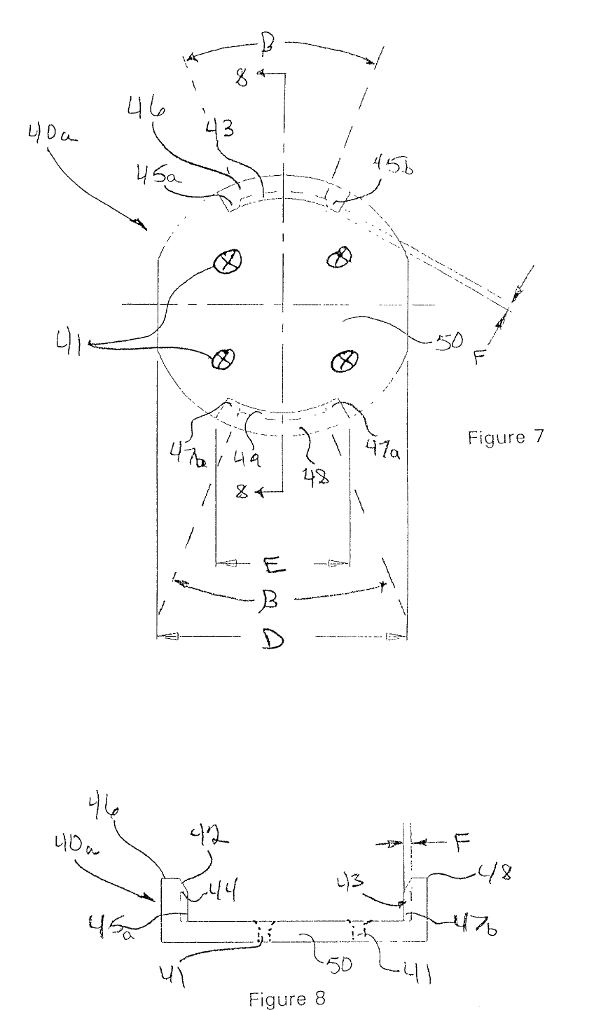

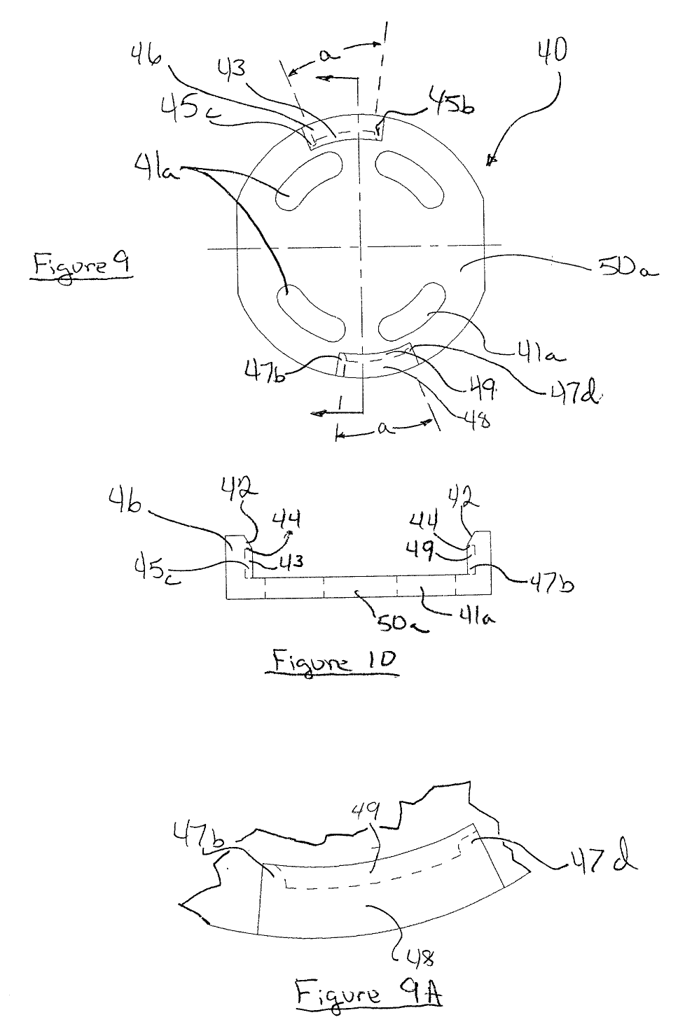

Referring more particularly the Figures, wherein like numbers refer to similar parts, the interface of one preferred embodiment of a cleat 20 and hook plate 40 in accordance with the present invention is illustrated in FIGS. 1 and 2. FIG. 1 illustrates a preferred embodiment of the cleat 20 received and retained by a preferred embodiment of an asymmetrical release hook plate 40. The cleat 20 is configured to be compatible with SPD-type cycling shoes. It will be understood by those of skill in that to be SPD compatible, a cleat will fit in the cleat recess of an SPD-type cycling shoe with little, or preferably no modification to the shoe. An SPD compatible cleat is generally characterized by a compact size and reduced thickness that does not interfere with walking in cycling shoes equipped with the cleats. More particularly, an SPD compatible cleat is characterized in that two fasteners pass through the cleat to engage the sole of the shoe. One preferred embodiment of the cleat 20 is illustrated in FIGS. 3-6. A preferred embodiment of an asymmetrical release hook plate 40 is illustrated in FIGS. 9 and 10. FIGS. 7 and 8 illustrate an alternative symmetrical release hook plate 40a.

With reference to FIGS. 3-6A, one preferred embodiment of the cleat body 25 is generally circular and includes two fastener openings 22. The fastener openings 22 are sized and arranged to be compatible with SPD-type cycling shoes. SPD-type cycling shoes have two fastener receiving inserts arranged transverse to the length of the shoe (the length being measured toe to heel) generally under the ball of the rider's foot. Resilient retaining mechanisms 30 project from front and rear facing portions of the circumferential edge 28 of the cleat 20. The resilient retaining mechanisms 30 project from the circumferential edge 28 directed toward to the toe and heel of the rider's foot, respectively.

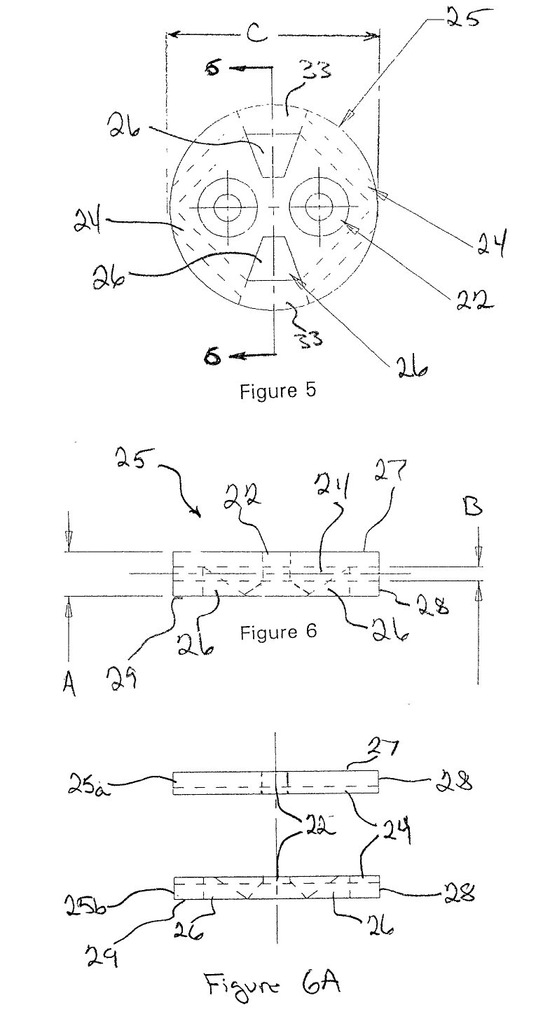

The illustrated embodiment of a cleat 20 may be constructed as a monolithic cleat body 25 that preferably retains two resilient engagement mechanisms 30. The term “monolithic” as use in this application refers to a cleat body 25 cast or machined as a single piece. With reference to FIG. 5, it can be seen that the preferred embodiment of the cleat body is generally symmetrical. Restated, if the cleat body 25 of FIG. 5 is bisected along line 6-6 or a perpendicular to line 6-6, each half of the bisected cleat body will be identical. The cleat body 25 is mounted to the bottom of a cycling shoe so that top surface 29 is adjacent the sole of the shoe and bottom surface 27 is directed downwardly away from the shoe. The bottom surface 27 of the cleat body includes four openings. The two fastener openings 22 flare as they approach the bottom surface 27 to accommodate the tapered head of the fasteners (not illustrated). The narrowed portions of the fastener openings 22 pass through the cleat body 25 to the upper surface 29, permitting the fasteners to threadably engage the SPD-type cycling shoe as is known in the art.

Along the median of the cleat 20 (FIG. 3, line 4-4), the cleat body 25 defines front and rear mud relief ramps 26. Each mud relief ramp 26 is configured to connect an opening 33 behind the protruding portion 32 of each resilient retaining mechanism 30 to the bottom surface 27. The mud relief ramps 26 permit any dirt, mud or other contaminants that may become trapped behind the projecting portion 32 of the resilient retaining mechanisms 30 to exit the cleat. Thus, built-up mud or debris does not impair the freedom of movement of the resilient retaining mechanisms 30.

The cleat body 25 also includes a circumferential edge 28 generally perpendicular to both the top surface 29 and the bottom surface 27. The circumferential edge 28 defines front and rear openings 33 through which front and rear protruding portions 32 of the resilient urging mechanisms 30 extend beyond the periphery of the cleat body 25. Retaining channels 24 are configured to receive and retain each V-shaped resilient retaining mechanism 30. The retaining channels 24 communicate with the front and rear openings 33. The retaining channels 24 are also open where they extend through the circumferential edge 28 of the cleat body 25. The open-ended configuration of each leg of the retaining channels 24 prevents movement of the resilient retaining mechanisms 30 from being restricted by built-up debris. Any debris in the front and rear openings 33 or retaining channels is easily ejected through the mud relief ramps 26 and open ends of the retaining channels 24.

FIG. 6A illustrates an alternative cleat body constructed from top and bottom portions 25a, 25b. The alternative cleat body top and bottom portions 25a, 25b are preferably provided with indexing means for ensuring alignment of the two portions. The split cleat body portions 25a, 25b are preferably held together by the same fasteners used to fix the cleat 20 to a cycling shoe. This split configuration permits the resilient retaining mechanisms 30 to be placed in their respective retaining channels 24 and then fixed to the cyclists shoe. Adjustment of the spring force exerted by the resilient retaining mechanisms 30 is easily adjusted by disassembling the cleat 20 and replacing the resilient retaining mechanisms 30. Any of the cleat bodies disclosed in this application may be split to facilitate mounting and replacement of the retaining mechanisms.

With particular reference to FIGS. 3 and 4, each V-shaped resilient retaining mechanism 30 is preferably manufactured from spring wire. More preferably, the resilient retaining mechanisms 30 are formed of super elastic nickel titanium wire. Each resilient retaining mechanism 30 is slidably received in the retaining channels 24. Pressure exerted on the protruding portion 32 of the resilient retaining mechanism 30 forces the protruding portion 32 into the opening 33 against the spring force of the retaining mechanism 30. The leg portions of each resilient retaining mechanism 30 slide in the retaining channels 24 toward the relief holes in the circumferential edge 28 of the cleat body 25. When the pressure exerted on the protruding portion 32 is removed, the resilient urging mechanism 30 rebounds to its original position projecting from the front and rear of the cleat body 25. It will be understood by those of skill in the art that the action of compressing and releasing the resilient urging mechanism 30 will force any contaminants out the open ends of the retaining channels 24 and mud relief ramps 26 defined by the cleat body 25.

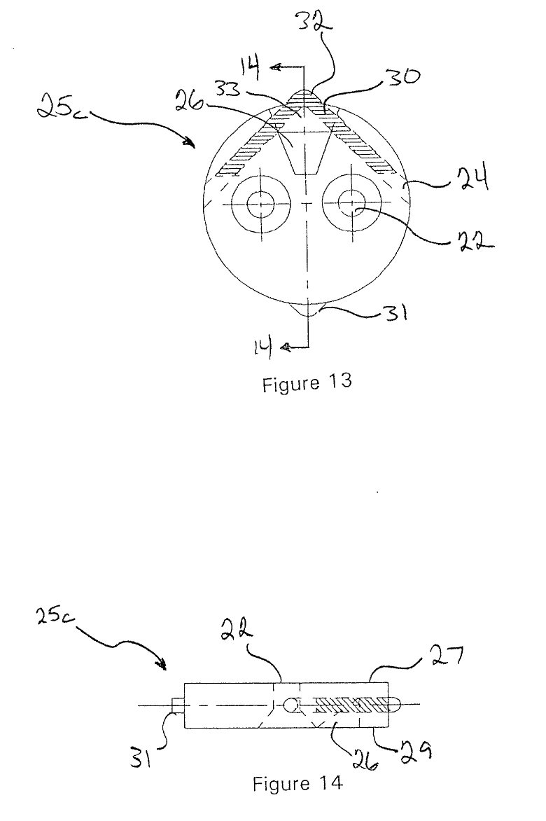

Several alternative embodiments of a cleat 20 are illustrated in FIGS. 13-20. FIGS. 13 and 14 illustrate a cleat body 25c having a single retaining channel 24 and associated mud relief ramp 26. A single resilient retaining mechanism 30 is retained in the retaining channel 24. A fixed protrusion 31 projects from the rear portion of the circumferential edge 28 for engagement with the rear hook 48 of a hook plate 40, 40a. Rotation of the cleat body 25c relative to the hook plate 40, 40a will cause the release ramps 47b, 47d to eject the protrusion 31 from the rear retaining channel 49. The opposed resilient retaining mechanism 30 will be similarly ejected from the front retaining channel 43 by the front release ramps 45c, 45b as will be described in greater detail below.

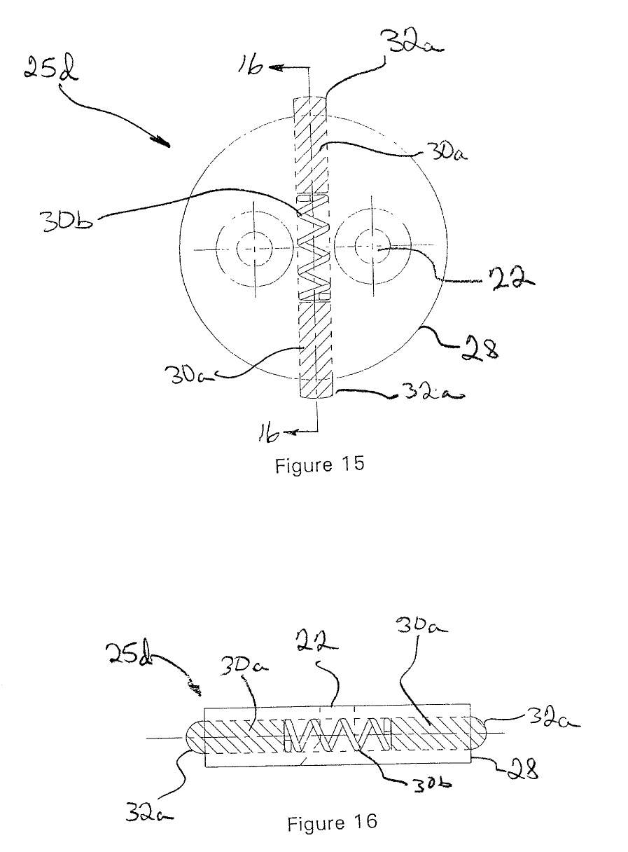

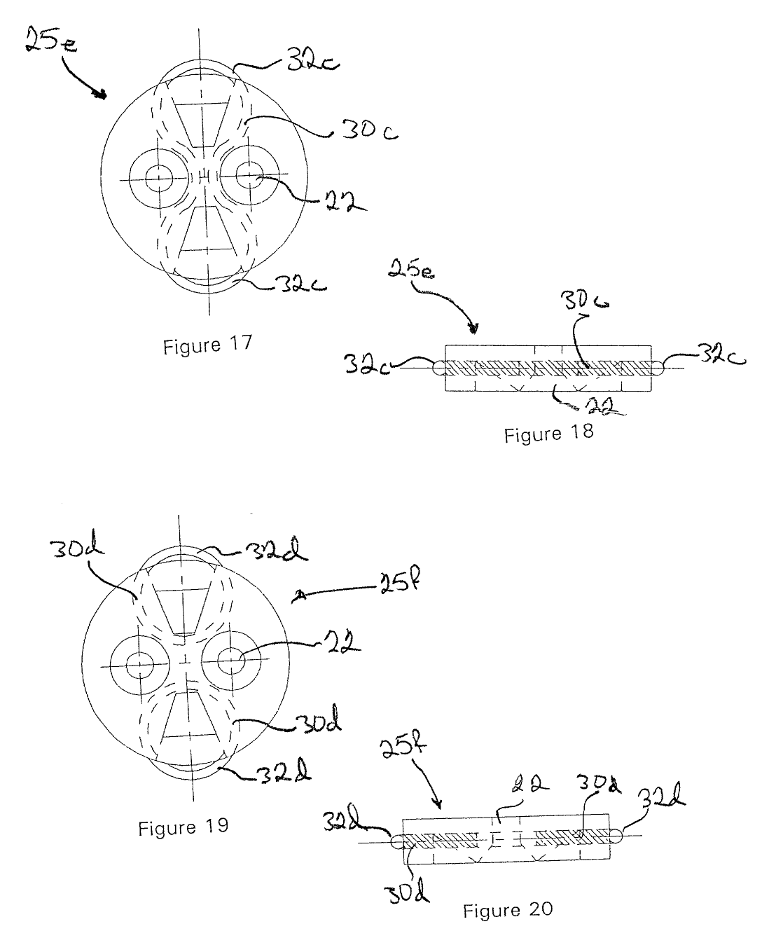

FIGS. 15 and 16 illustrate a further alternative cleat body 25d where the retaining mechanisms 30a are rigid and the resilient bias is provided by a coiled wireform 30b. Portions 32a of the rigid retaining mechanisms project from the front and rear of the circumferential edge 28 to engage the front and rear hooks 46, 48 of the hook plate 40, 40a. FIGS. 17 and 18 illustrate an alternative cleat body 25e incorporating a resilient retaining mechanism configured as a continuous wireform 30c. The continuous wireform 30c includes projecting portions 32c. FIGS. 19 and 20 illustrate an alternative cleat body 25f incorporating two alternative resilient retaining mechanisms configured as circular wireforms 30d. Each of the circular wirefoms 30d include projecting portions 32d.

With reference to the alternative embodiments of cleat body illustrated in FIGS. 3-6A and 13-20, it will be understood that each configuration of cleat body will incorporate retaining channels 24 and relief ramps 26 and/or openings that permit resilient deflection of the protruding portions 32 for cleat engagement with and ejection from the 30 hook plates 40, 40a as described in greater detail below with reference to FIGS. 1,2 and 7-10.

With reference to FIGS. 7-10, each hook plate 40, 40a comprises a base plate 50 for mounting the hook plate 40 to a pedal of a cycling machine (not illustrated). Four fastener openings 41, 41a are configured to receive fasteners (not illustrated) for fastening the hook plate 40 to the pedal. The front and rear extremities of the hook plate include a front hook 46 and a rear hook 48, each configured to project generally perpendicular to and away from the base plate 50. Each hook includes a beveled surface 42 that guides the cleat 20 into the hook plate and compresses the retaining mechanism 30 by acting on the protruding portion 32. Each hook 46, 48 also includes an engagement surface 44 below the beveled surface for preventing upward movement of a received protruding portion 32 (see FIG. 2).

Each front hook 46 defines a front retaining channel 43 and each rear hook 48 defines a rear retaining channel 49. The inward and outward limits (corresponding to left and right of FIGS. 7 and 9, respectively) of each retaining channel 43, 49 are defined by release ramps 45, 47. The retaining channels 43, 49 curve along the periphery of the hook plate 40, 40a. It is important to note that the generally circular configuration of the cleat 20 and the complementary curved front and rear hooks 46, 48 result in a clipless pedal having an axis of cleat rotation centered under the rider's foot. The protruding portions 32 of the retaining mechanisms 30 project into the front and rear retaining channels 43, 49. Engagement of the cleat 20 against the base plate 50 determines the position of the protruding portions 32 relative to the engagement surfaces 44. A cleat 20 (FIGS. 1 and 2) engaged in a hook plate 40, 40a is permitted to rotate freely or “float” in a horizontal plane relative to the hook plate 40 but is not permitted to separate from the hook plate 40 by the action of the retaining surfaces 44 on the protruding portions 32. These relationships will be further discussed below.

FIGS. 1 and 2 illustrate a preferred SPD compatible cleat 20 engaged in a preferred asymmetrical release hook plate 40. During insertion of the cleat 20 into the hook plate 40, the protruding portions 32 of the resilient retaining mechanisms 30 are forced back into the cleat body 25 by downward pressure and the interface of beveled surface 42 with projecting portions 32. Once the cleat body 25 is fully received against the hook plate 40, front retaining channel 43 and rear retaining channel 49 permit the protruding portions 32 to rebound to their projected positions. The protruding portions 32 are restrained from above by engagement surface 44. As long as the protruding portions remain within the front retaining channel 43 and rear retaining channel 49, respectively, there is a secure engagement between the cleat 20 and the hook plate 40.

The cleat 20 and hook plate 40, 40a are configured so that the cleat is permitted free rotation or float between the release ramps 45, 47 that define the lateral limits of the retaining channels 43, 49. When rotation of the cleat, i.e., angular movement of the rider's foot relative to the pedal-mounted hook plate 40, approaches the limit of permitted float, the protruding portions 32 of the resilient retaining mechanisms 30 encounter laterally opposed release ramps 45, 47. The release ramps 45, 47 resist further angular movement of the protruding portions 32. The extent of this resistance is determined by the configuration of the release ramps 45, 47 and the physical properties of the resilient urging mechanisms 30. A sufficient angular force by the protruding portions 32 against the release ramps 45, 47 will compress the protruding portions within the cleat body 25. When the protruding portions 32 are compressed within the cleat body 25, the cleat 20 is released from the hook plate 40.

With reference to FIGS. 7 and 9, it can be seen that the location and angular extent of the front and rear hooks 46, 48 of the asymmetrical release hook plate 40 and symmetrical release hook plate 40a are different. In asymmetrical release hook plate 40 (FIG. 9), the front hook 46 is located left of center while rear hook 48 is located right of center. The asymmetrical hook plate 40 illustrated FIG. 9 would be installed on the right hand pedal of a cycling machine. The hook plate 40 is illustrated so that the top of the hook plate in the figure corresponds to the front of the cycling machine and the left portion of the hook plate corresponds to a direction toward the cycling machine. The configuration of the asymmetrical release hook plate 40 permits approximately 28° of float, approximately 20° of which is outward (the heel of the rider's shoe moving away from the cycling machine) and approximately 8° of which is inward float (the heel of the cyclist's shoe moving toward the cycling machine). This configuration means that the cleat 20, i.e., the rider's foot, will be released from the pedal-mounted hook plate, when the heel of the rider's foot exceeds 8° of inward movement or 20° of outward movement relative to the pedal.

With continuing reference to FIG. 9, the fastener openings 41a in the illustrated asymmetrical hook plate 40 are configured as arcuate slots. These slots 41a permit the rider to adjust the inward and outward release points by altering the orientation of the hook plate 40 relative to the pedal. I will be understood by those of skill in the art that arcuate fastener slots 41 a also permit the cyclist to select an asymmetrical release pattern for an otherwise symmetrical hook plate such as 40a. Symmetrical hook plates having varying degrees of float may be mounted at selected angular orientations to the pedal to produce an asymmetrical release of the cleat. Restated, the arcuate fastener slots permit the cyclist to adjust the inward and outward release points without reducing the overall amount of float.

It should also be noted that the inward release ramps 45b, 47b have a higher profile than the outward release ramps 45c, 47c as best illustrated in FIG. 9A. This arrangement causes the pre-release resistance to inward movement of the rider's foot to be greater than the pre-release resistance to outward movement of the rider's foot. Higher pre-release resistance to inward movement may help the rider control the bicycle during certain maneuvers. The higher resistance to inward movement of the rider's foot is easily overcome by forces generated in a crash. Differently configured inward and outward release ramps, combined with arcuate fastener openings 41a, permit the rider to control not only the location but also the “feel” of the cleat release points.

The symmetrical release hook plate 40a, illustrated in FIG. 7, permits approximately 40° of float with 20° being inward and 20° being outward float. This configuration means that the rider's foot will release from the pedal when the heel of the rider's foot exceeds 20° of angular movement, inward or outward, relative to the pedal. In either the asymmetrical or symmetrical release hook plate, the cleat is free to rotate (in a horizontal plane) relative to the hook plate 40, 40a within the range of float α, β. Under normal riding conditions, the rider will be able to feel the inward and outward limits defined by the release ramps 45, 47. During a crash or other emergency maneuver, the release resistance is easily overcome permitting release of the rider from the bicycle.

Hook plates 40, 40a may preferably be configured to mount to conventional pedals. Thus, a conventional pedal can be converted to a clipless pedal compatible with SPD type cycling shoes merely by installing hook plates 40, 40a on the upper and lower surfaces of the pedal. Alternatively, a dedicated low-profile pedal may be configured to receive upper and lower hook plates.

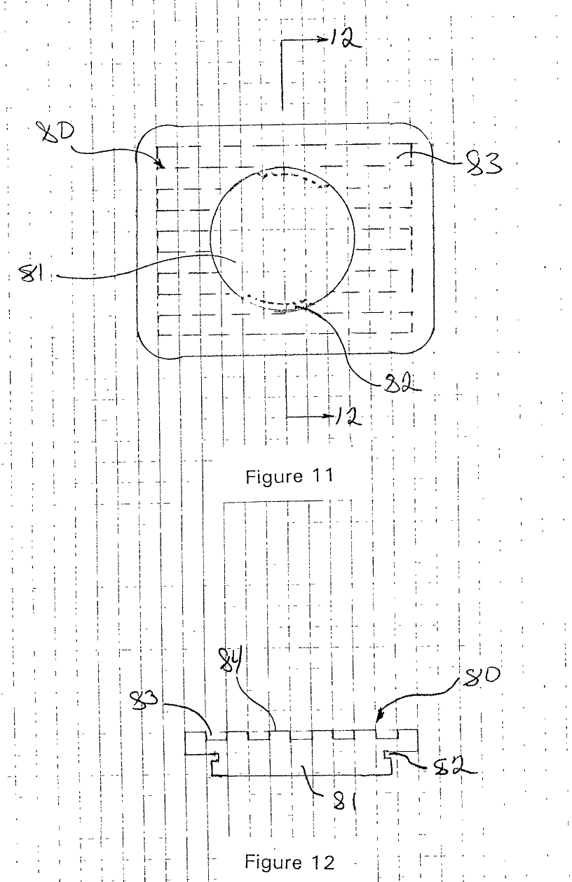

FIGS. 11 and 12 illustrate a pedal pad 80 in accordance with another aspect of the invention. If the hook plates 40, 40a are installed on a conventional pedal, there may be situations in which the rider does not wish to be engaged to the pedal or in which a different rider, not equipped with compatible shoes, wishes to use the bicycle. An elastic, rubber or plastic pad 80 configured to engage the front and rear hooks is provided so that the hook plates can be covered and the bicycle can be ridden in a more casual way. Each pedal pad 80 is preferably molded from flexible hard rubber or elastomeric material. The pad 80 includes a pattern of recesses 83 on the top surface 84 for enhanced traction. A generally circular projection 81 extends from the bottom of the pedal pad 80. The projection 81 is configured to be received between the front and rear hooks 46, 48. Front and rear grooves 82 receive the beveled and engagement surfaces 42, 44 to retain the pedal pad to the hook plate 40, 40a. The illustrated pedal pad 80 is configured for an asymmetrical release hook plate 40a. The pads covering the hook plates permit the rider with SPD shoes to ride without engagement to the pedals and also permit the casual rider with non-cycling shoes to enjoy the bicycle.

It is also possible for a cyclist to equip his bicycle with alternative release patterns by configuring one surface of his pedals with, for example, an asymmetrical release hook plate 40 while equipping the other surface of the pedal with a symmetrical release hook plate 40a. Alternatively, the cyclist could adjust the release angles using the arcuate faster openings 41a of FIG. 9 to have alternative release patterns on either side of the pedal. To avoid the danger of having each foot in a differently configured hook plate, pedal pads 80 may be used to block engagement with the alternative hook plate. The pedal pads 80 may be weighted, or be configured to have a weight sufficient to maintain the pedal in a position where the open hook plate is accessible and the blocked hook plate is oriented away from the rider. In this manner, when circumstances require it, the cyclist has available alternative levels and patterns of float.

The cleat body 25 is preferably formed from durable, lightweight, corrosion resistant metal such as aluminum, titanium, alloy steel, etc. The resilient retaining mechanisms 30 must be formed from extremely tough material that can be imbued with spring properties. A stainless steel wireform is certainly compatible with the present invention. However, a nickel titanium wireform has several distinct advantages over stainless steel. First, nickel titanium is lighter, more corrosion resistant and includes similar strength characteristics to stainless steel. More importantly, nickel titanium wireforms of the same diameter can be provided with markedly different elastic properties by varying the forming and heat treatment during manufacture of the resilient retaining mechanisms. This unique property of nickel titanium has the advantage of permitting the release force and engagement force of the inventive clipless pedal interface 100 to be adjusted by installation of alternative wireforms, each of which has exactly the same external diameter. As a result, only the wireforms need be changed and the engagement of the resilient retaining mechanism with the hook bodies remains consistent. The nickel titanium wireforms may also be provided with any of a plurality of coatings, among them a diamondlike carbon (DLC) that provide an extremely hard and slippery surface to enhance durability and reduce friction between the retaining mechanisms and the cleat body 25.

It will be understood by those of skill in the art that, while nickel titanium shape memory alloy materials are preferred, other shape-memory materials share many of the desirable characteristics of Nickel Titanium and may be appropriate for use in conjunction with the present invention. Shape memory alloy materials include Nickel Titanium, Copper Nickel Titanium, Iron doped Nickel Titanium, Copper Aluminum Nickel, Copper Tin (bronze), Copper Zinc (brass), Copper Zinc alloyed with a few percent by weight of Silicon, Tin or Aluminum, Iron Platinum, Manganese Copper and Iron Manganese Silicon. Shape memory alloy materials share physical characteristics that allow their elasticity to be adjusted by altering the proportions of the constituent alloys, heat treatment, cold working and other techniques known in the art. Thus, while the form and external dimensions of components manufactured from shape memory materials stay the same, the spring characteristics, rebound force, elasticity, etc. can be adjusted over a wide range. This unique collection of properties makes shape memory alloy materials particularly suitable for applications such as the clipless pedal system.

While a preferred embodiment of the foregoing invention has been set forth for purposes of illustration, the foregoing description should not be deemed a limitation of the invention herein. Accordingly, various modifications, adaptations and alternatives may occur to one skilled in the art without departing from the spirit and scope of the present invention.

What is claimed is:

1. A clipless bicycle pedal system for releasably binding the sole of a rider's shoe to a pedal, said system comprising:
a hook plate comprising:
a generally planar base plate having a top and a bottom, a first end and a second end opposed to said first end, said base plate defining a plurality of fastener openings through which a plurality of fasteners are receivable to fix said hook plate to the pedal;
a first hook projecting generally perpendicular to said base plate from said first end and defining an arcuate front retaining channel; and
a second hook projecting generally perpendicular to said base plate from said second end and defining an arcuate rear retaining channel; and
a cleat attachable to a sole of a cycling shoe, said sole having a toe end and a heel end and a plurality of bores according to a first industry standard, said cleat comprising:
a cleat body having an upper sole side and a lower pedal side, said cleat body defining a plurality of fastener openings extending through said cleat body from said lower pedal side to said upper sole side and configured so that fasteners passing through said fastener openings are alignable with said plurality of bores;
at least one resilient retaining mechanism biased to protrude from said cleat body;
wherein said cleat body is receivable between said front and rear hooks with said pedal side against said base plate and said at least one resilient retaining mechanism is received in at least one of said front or rear retaining channels such that said cleat is retained to said hook plate but permitted to rotate relative to said hook plate with said resilient retaining mechanism moving in a lateral arcuate path along said at least one of said front or rear retaining channels.

2. The clipless pedal system of claim 1, wherein said first industry standard is an SPD standard and said plurality of fastener openings comprises two openings arranged according to said SPD standard.

3. The clipless pedal system of claim 1, wherein said cleat rotates around an axis of rotation defined by said front and rear retaining channels.

4. The clipless pedal system of claim 3, wherein said axis of rotation generally coincides with a geometric center of said cleat body and said hook plate.

5. The clipless pedal system of claim 4, wherein each of said front and rear retaining channels have equivalent arcuate extents defined between inward and outward lateral limits and said at least one resilient retaining mechanism is permitted free lateral movement in said front or rear retaining channels between said lateral limits.

6. The clipless pedal system of claim 5, wherein said inward and outward lateral limits are defined by release ramps, each said release ramp comprising a surface that resists lateral movement of said at least one resilient retaining mechanism beyond said inward or outward limit and to compress said at least one resilient retaining mechanism into said cleat body when said lateral movement exceeds said inward or outward limit, whereby said cleat is released from said hook plate.

7. The clipless pedal system of claim 6, wherein said pedal rotates about a pedal axis, said hook plate is fixed to said pedal and the arcuate extent of said front and rear retaining channels are bisected by a line perpendicular to said pedal axis passing through said axis of rotation.

8. The clipless pedal system of claim 6, wherein said pedal rotates about a pedal axis, said hook plate is fixed to said pedal and the arcuate extent of said front and rear retaining channels are divided into unequal first and second arcs by a line perpendicular to said pedal axis passing through said axis of rotation, said front retaining channel first arc subtending an angle equal to an angle subtended by said rear retaining channel second arc.

9. The clipless pedal system of claim 1, wherein said front and rear retaining channels comprise portions of a first circle having a center and each of said base plate fastener openings comprise an arcuate slot, said arcuate slots being portions of a second circle concentric with said first circle, whereby said hook plate is fixable to said pedal at a plurality of angular orientations relative to said pedal.

10. A clipless bicycle pedal system comprising:
a hook plate fixable to a pedal, said hook plate comprising:
a base plate having a front end, a rear end, a pedal side and an opposite top side;
a front hook projecting generally perpendicular to said top side at said front end and defining a front retaining channel; and
a rear hook projecting generally perpendicular to said top side at said rear end and defining a rear retaining channel; and
a cleat fixable to the sole of a cycling shoe, said sole having a toe end and a heel end, said cleat comprising:
a cleat body having a sole side, a pedal side, a toe end, a heel end and a peripheral edge connecting said sole side to said pedal side;
a first retaining mechanism protruding from said peripheral edge at said toe end; and
a second retaining mechanism protruding from said peripheral edge at said heel end,
wherein at least one of said first or second retaining mechanisms is movable relative to said cleat body from a protruding position to a non-protruding position and is resiliently biased toward said protruding position and said cleat body is receivable in said hook plate and said first and second retaining mechanisms are engaged in said front and rear retaining channels,
whereby movement of a received cleat relative to said hook plate is restricted to rotation in a plane parallel to said base plate with said first and second retaining mechanisms moving laterally in said front and rear retaining channels.

11. The clipless pedal system of claim 10, wherein said front and rear retaining channels define an arcuate path such that movement of said first and second retaining mechanisms occurs about an axis of rotation passing approximately through a center of said sole and pedal surfaces.

12. The clipless pedal system of claim 11, wherein said front and rear retaining channels each comprise inward and outward lateral limits, said inward and outward lateral limits defined by a release ramp comprising a surface which, at a pre-determined angular orientation of said cleat relative to said body and in response to rotation of said cleat beyond said pre-determined angular orientation, acts to eject said first and second retaining mechanisms from said front and rear retaining channels.

13. A cleat for attachment to a sole of a bicycle shoe for use with a clipless bicycle pedal, said sole having a toe end and a heel end and a plurality of threaded bores having a spacing and alignment according to a first industry standard, said cleat comprising:
a cleat body having an upper sole side and a lower pedal side, a toe end, a heel end and a peripheral edge connecting said sole and pedal sides, said cleat body defining a plurality of fastener openings extending through said cleat body and configured so that fasteners passing through said fastener openings are alignable with said plurality of bores, said cleat body further defining at least one retaining channel communicating with at least one opening in said peripheral edge; and
at least one resilient retaining mechanism disposed in said retaining channel and protruding beyond said peripheral edge through said opening.

14. The cleat of claim 13, wherein said cleat body is substantially circular.

15. The cleat of claim 13, wherein said at least one retaining channel comprises first and second V-shaped retaining channels arranged so that the point of said first V-shaped retaining channel communicates with an opening in said peripheral edge at said toe end and the point of said second V-shaped retaining channel communicates with an opening in said peripheral edge at said heel end; and
said at least one resilient retaining mechanism comprises first and second V-shaped wireforms, each said V-shaped wireform comprising two legs and a junction between said legs, said first V-shaped wireform disposed in said first V-shaped retaining channel in a first position where said junction protruding through said toe end opening and said second V-shaped wireform disposed in said second V-shaped retaining channel in a first position where said junction protruding through said heel end opening;
each of said resilient retaining mechanisms biased toward said first position and movable against said bias from said first position to a second position where said wireforms do not protrude beyond said peripheral edge.

16. The cleat of claim 15, wherein said V-shaped wireforms are made of shape memory alloy material.

17. The cleat of claim 16, wherein said shape memory alloy material is selected from the group consisting of Nickel Titanium, Copper Nickel Titanium, Iron doped Nickel Titanium, Copper Aluminum Nickel, Copper Tin (bronze), Copper Zinc (brass), Copper Zinc alloyed with a few percent by weight of Silicon, Tin or Aluminum, Iron Platinum, Manganese Copper and Iron Manganese Silicon.

18. The cleat of claim 13, wherein said at least one resilient retaining mechanism comprises a closed shape of wireform material.

19. The cleat of claim 18, wherein said closed shape protrudes from both said toe end and said heel end of said cleat body.

20. The cleat of claim 13, wherein said cleat body comprises top and bottom portions configured to be fixed together by said fasteners to retain said at least one resilient retaining mechanism.

21. The cleat of claim 13, wherein said at least one resilient retaining mechanism is constructed of Nickel Titanium material.

22. The cleat of claim 13, wherein said at least one resilient retaining mechanism is made of shape memory alloy material.

23. The cleat of claim 22, wherein said shape memory alloy material is selected from the group consisting of Nickel Titanium, Copper Nickel Titanium, Iron doped Nickel Titanium, Copper Aluminum Nickel, Copper Tin (bronze), Copper Zinc (brass), Copper Zinc alloyed with a few percent by weight of Silicon, Tin or Aluminum, Iron Platinum, Manganese Copper and Iron Manganese Silicon.
